(19) United States
(12) Patent Application Publication
(10) Pub. No.: US 2021/0263214 A1
(43) Pub. Date: Aug. 26, 2021

(54) Mode Equalization Filter

(71) Applicant: Nippon Telegraph and Telephone Corporation, Tokto (JP)

(72) Inventors: Hirotaka Ono, Musashino-shi, Tokyo (JP); Takayuki Mizuno, Musashino-shi, Tokyo (JP); Koki Shibahara, Musashino-shi, Tokyo (JP); Yutaka Miyamoto, Musashino-shi, Tokyo (JP)

(21) Appl. No.: 17/252,814

(22) PCT Filed: Jul. 12, 2019
(86) PCT No.: PCT/JP2019/027673

§ 371 Date: Dec. 16, 2020

(30) Foreign Application Priority Data
Jul. 19, 2018 (JP) 2018-136150

(51) Int. Cl. G02B 6/028; G02B 6/02; F21V 8/00

(52) U.S. Cl. CPC G02B 6/0288; G02B 6/002; G02B 6/02052; G02B 6/02047

(57) ABSTRACT

Provided is a mode equalization filter that reduces a light intensity difference between multiple modes of signal light propagating in a core of a few-mode fiber. The mode equalization filter according to the present invention includes: a collimator lens that collimates the signal light emitted from the few-mode fiber; a partial ND filter including a small dot having small transmittance with respect to the collimated signal light; and condensing lenses that condense the signal light transmitted through the partial ND filter on the few-mode fiber. The small dot having the small transmittance is arranged in a part of the partial ND filter, and the partial ND filter is arranged such that, when the collimated signal light is transmitted, a part of the collimated signal light overlaps with the small dot having the small transmittance.

### TECHNICAL FIELD

The present invention relates to a mode equalization filter, and more particularly to a mode equalization filter that reduces a difference in transmission loss between modes in a multimode optical fiber.

### BACKGROUND ART

As the speed and capacity of communication services increase, traffic transmitted by a main line optical transmission system is increasing explosively. In order to cope with the increase in traffic in a mission-critical system, techniques for dramatically increasing the transmission capacity of the optical transmission system are under study. Among various transmission methods, technical development related to mode-division multiplexing (hereinafter referred to as MDM) optical transmission has been rapidly progressing in recent years. It is known that such an MDM optical transmission system can superimpose different signals on each of a plurality of different modes of an optical signal and can transmit the superimposed signals over a long distance (Non-Patent Literature 1). In the MDM transmission system, since an original signal is retained even when mode conversion occurs when the optical signal propagates in the optical fiber, it is also known that a receiver can identify and receive signals in a plurality of different modes with signal processing using a multiple-input and multiple-output (MIMO) technique.

In such an MDM optical transmission system, the optical fiber used for transmitting the optical signal is a few-mode fiber (hereinafter referred to as FMF) designed such that the optical signal propagates in only a predetermined mode set as a permissible mode.

### Citation List

### Non-Patent Literature

Non-Patent Literature 1: K. Shibahara et al., “Dense SDM (12-core×3-mode) transmission over 527 km with 33.2-ns mode-dispersion employing low-complexity parallel MIMO frequency-domain equalization”, Journal of Lightwave Technology, Jan. 1, 2016, vol. 34, No. 1, p. 196-204

### SUMMARY OF THE INVENTION

### Technical Problem

A transmission loss with respect to a transmission distance of an optical signal propagating inside an FMF differs depending on a mode of the optical signal (mode-dependent loss). In addition, an optical amplifier used in an MDM optical transmission is an optical amplifier capable of optically amplifying a mode that is the same or higher than the mode in which the FMF allows propagation, and a gain value differs for each mode. Therefore, when the optical signal is transmitted over a long distance by a long-distance MDM optical transmission system, an optical power difference of the optical signal between respective modes increases with the transmission distance, and when the optical power is further optically amplified, a lager optical power difference of the optical signal is generated between the respective modes, resulting in causing variations in transmission characteristics of the optical signal between the modes. As a result, the transmission distance of the optical signal may be restricted (Non-Patent Literature 1).

### Means for Solving the Problem

The present invention has been made to solve the above problems, and an object thereof is to provide a mode equalization filter for reducing an optical power difference between modes of an optical signal propagating inside an FMF.

An embodiment of the present invention is to provide a mode equalization filter that reduces a difference in light intensity between multiple modes of signal light propagating in a core of a few-mode fiber, the mode equalization filter includes: a collimator lens that collimates the signal light emitted from the few-mode fiber; a partial ND filter including a small dot having small transmittance with respect to the collimated signal light; and condensing lenses that condense the signal light transmitted through the partial ND filter on the few-mode fiber, wherein the small dot having the small transmittance is arranged in a part of the partial ND filter, and the partial ND filter is arranged such that, when the collimated signal light is transmitted, a part of the collimated signal light overlaps with the small dot having the small transmittance.

### Effects of the Invention

The present invention has an effect that a transmission distance of an optical signal is not restricted due to a difference in optical power between propagation modes by reducing the difference in optical power between propagation modes in an MDM optical transmission system.

### BRIEF DESCRIPTION OF DRAWINGS

FIG. 1 is a perspective view schematically showing a configuration of a mode equalization filter according to a first embodiment of the present invention.

FIG. 2 is a diagram of optical power distribution in cross sections of an FMF core in a mode in which light propagates in a 6-LP mode fiber. FIGS. 2(a) to 2(j) correspond to modes of LP₀₁, LP₁₁ₒ, LP₁₁ₑ, LP₂₁ₒ, LP₂₁ₑ, LP₀₂, LP₃₁ₒ, LP₃₁ₑ, LP₁₂ₒ, and LP₁₂ₑ, respectively.

FIG. 3 is a diagram of optical power distribution in cross sections of the FMF core showing a state where the LP₃₁ₒ mode and the LP₃₁ₑ mode are degenerated. FIG. 3(a) is an optical power distribution in the odd mode LP₃₁ₒ, FIG. 3(b) is an optical power distribution in the even mode LP₃₁ₑ, and FIG. 3(c) is an optical power distribution in the degeneracy mode LP₃₁ of the odd mode and the even mode.

FIG. 4 is a graph showing dependency of a transmission loss given by the mode equalization filter on a radius of a small dot (when a transmittance and the shift amount of the small dot are 0.5 and 0 μm, respectively).

FIG. 5 is a graph showing dependency of a transmission loss given by the mode equalization filter on a transmittance of the small dot (when the radius and the shift amount of the small dot are 500 μm and 0 μm, respectively).

FIG. 6 is a graph showing dependency of a transmission loss given by the mode equalization filter on the shift amount of the small dot (when the radius and the transmittance of the small dot are 500 μm and 0.5, respectively).

FIG. 7 is a perspective view schematically showing a configuration of a mode equalization filter according to a second embodiment of the present invention.

### DESCRIPTION OF EMBODIMENTS

Embodiments of the present invention will be described in detail below. In addition, the embodiments of the present invention are not limited to the following examples without departing from the scope of the gist of the present invention.

In the following embodiments, a case where the number of propagation modes is 6 (hereinafter referred to as 6-LP-mode (10-mode)) is described, but the embodiments of the present invention are applicable without being limited in the number of propagation modes and is also applicable to the number of propagation modes different from the 6-LP-mode (10-mode).

### First Embodiment

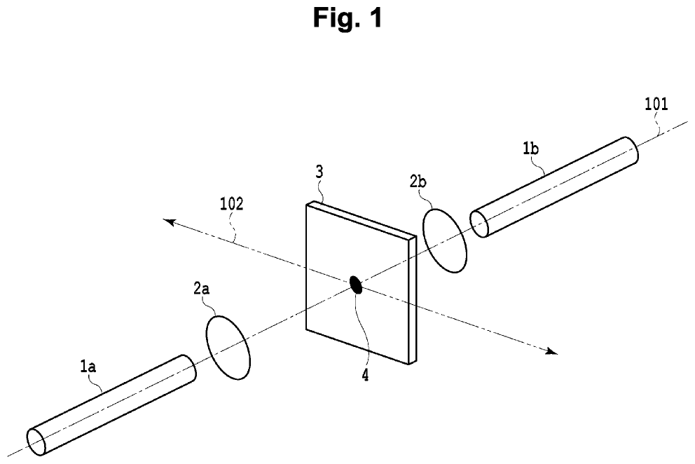

FIG. 1 is a perspective view schematically showing a configuration of a mode equalization filter according to a first embodiment of the present invention. The mode equalization filter of the present embodiment includes a collimator lens 2a, a condensing lens 2b, a partial ND filter 3, and a small dot 4 provided on the partial ND filter 3 and having small transmittance.

Here, a “small dot” in the small dot 4 having the small transmittance means a “small piece” or a “small portion”, and does not specify that a shape is circular or round.

An arrangement of respective components included in the mode equalization filter will be described. In FIG. 1, an alternate long and short dash line is an optical axis 101 indicating an advancing direction of signal light. Further, an alternate long and two short dashes line is an axis 102 perpendicular to the optical axis. FMFs 1a and 1b, the collimator lens 2a, the condensing lens 2b, the partial ND filter 3, and the small dot 4 having the small transmittance are arranged along the optical axis 101, respectively. Then, the collimator lens 2a and the condensing lens 2b are located between the FMFs 1a and 1b, and the partial ND filter 3 and the small dot 4 having the small transmittance are aligned to be located between the collimator lens 2a and the condensing lens 2b.

The FMFs 1a and 1b are arranged so that a main axis of each of cores thereof coincides with the optical axis. Each of the FMFs 1a and 1b includes a core and a clad having a refractive index lower than that of the core, and the signal light propagates inside the core. In the present embodiment, since optical fibers having six propagation modes (hereinafter referred to as 6-LP-mode (10-mode) fiber) are used as the FMFs 1a and 1b, the number of propagation modes in which the light propagates inside the cores of the FMFs 1a and 1b is six (being 10 when an even mode and an odd mode are distinguished). In other words, the optical signal input from one end of the FMFs 1a and 1b propagates in the six propagation modes and is output from the other end while maintaining the propagation modes.

The collimator lens 2a is arranged so that a lens surface thereof faces the end of the FMF 1a. The collimator lens 2a condenses the signal light output from the end of the FMF 1a, collimates the signal light, and allows the optical signal to transmit.

The partial ND filter 3 has a flat plate shape and is arranged such that a normal line to a flat surface is parallel to the optical axis 101. The signal light transmitted through the collimator lens 2a is arranged so as to pass through a part of the small dot 4 provided on the partial ND filter 3 and having the small transmittance. In other words, the partial ND filter 3 and the small dot 4 having small transmittance are arranged such that a part of the cross section of the signal light, which transmits through the collimator lens 2a, parallel to the plane of the partial ND filter 3 overlaps with a part of the small dot 4 provided on the partial ND filter 3 and having the small transmittance. Out of the signal light, the signal light passing through the part of the small dot 4 having the small transmittance has a smaller optical power compared with the signal light passing through a part of the partial ND filter 3 where the small dot 4 having the small transmittance is not provided.

The condensing lens 2b is arranged such that one lens surface thereof faces the partial ND filter 3 and the small dot 4 having the small transmittance and the other lens surface faces an end of the FMF 1b. Out of the signal light transmitted through the partial ND filter 3 and the small dot 4 having the small transmittance, the signal light in the direction parallel to the optical axis 101 is condensed at the end of the FMF 1b by the condensing lens 2b.

Here, a material of the partial ND filter 3 is not particularly limited as long as the optical power of the signal light passing through the partial ND filter 3 is not reduced. For example, quartz glass (SiO₂) and other materials, that is, materials in which the optical power of the signal light is not reduced when the signal light passes can be used. The small dot 4 provided on the partial ND filter 3 and having the small transmittance is preferably provided on the partial ND filter 3 in a planar and smooth manner, and can be provided on the partial ND filter 3 by a known thin film manufacturing method, for example. In addition, the shape of the small dot 4 having the small transmittance is not particularly limited as long as the small dot overlaps with a part of the cross section of the collimated signal light and the optical signal has the smaller optical power after passing through the small dot compared with before passing through the small dot. A circular shape, an elliptical shape, a polygonal shape, or other shapes can be freely adopted.

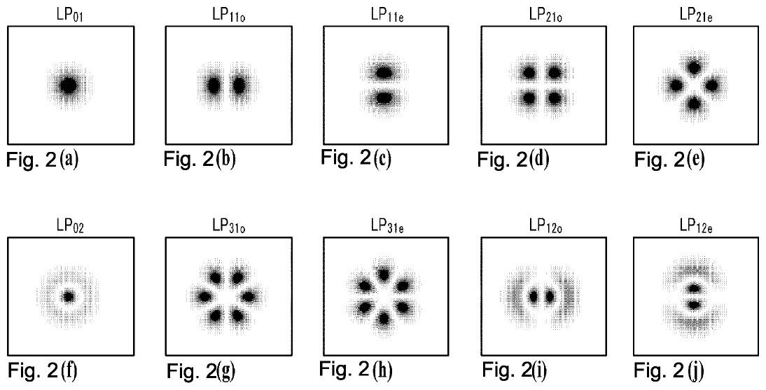

FIG. 2 is a diagram showing an optical power distribution in a cross section of an optical fiber in a mode in which light propagates in a 6-LP-mode fiber. In FIG. 2, as a black color darkens, the optical power becomes higher, and as a color is close to a white color (or a paper color) from the black color, the optical power becomes smaller. FIGS. 2(a) to 2(j) show optical power distributions in 10 propagation modes in which light propagates inside the cores of the FMFs 1a and 1b, respectively, and FIGS. 2(a) to 2(j) correspond to modes of LP₀₁, LP₁₁ₒ, LP₁₁ₑ, LP₂₁ₒ, LP₂₁ₑ, LP₀₂, LP₃₁ₒ, LP₃₁ₑ, LP₁₂ₒ, and LP₁₂ₑ, respectively. Here, the number in the subscripts of LP indicate states of the propagation mode, the subscript “o” indicates an odd mode, and the subscript “e” indicates an even mode.

Here, the LP_{11O} mode and the LP₁₁ₑ mode, the LP₂₁ₒ mode and the LP₂₁ₑ mode, the LP₃₁ₒ mode and the LP₃₁ₑ mode, and the LP₁₂ₒ mode and the LP₁₂ₑ mode are respectively converted by mode conversion during propagation in the 6-LP-mode, the odd modes o and even modes e are degenerated, respectively, and LP₁₁, LP₂₁, LP₃₁, and LP₁₂ are represented as degeneracy modes, respectively.

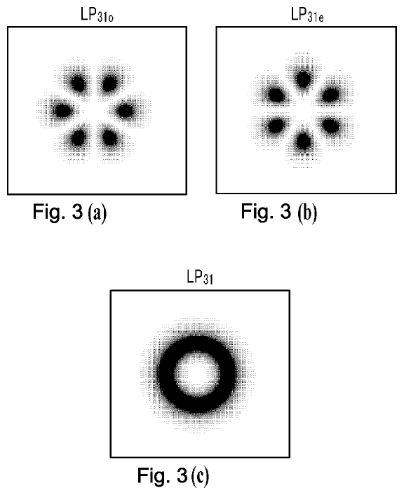

FIG. 3 is an optical power distribution diagram showing a state where the LP₃₁ₒ mode and the LP₃₁ₑ mode are degenerated. FIG. 3(a) shows an optical power distribution in the odd mode LP₃₁ₒ, FIG. 3(b) shows an optical power distribution in the even mode LP₃₁ₑ, and FIG. 3(c) shows an optical power distribution in the degeneracy mode LP₃₁ of the odd mode and the even mode.

Further, since the LP₂₁ and LP₀₂ modes, and the LP₃₁ and LP₁₂ modes have very close propagation constant values, mode conversion frequently occurs during propagation inf the cores of the FMFs 1a and 1b. As a result, optical characteristics are hardly distinguished between two modes, that is, the LP₂₁ and LP₀₂ modes and between the LP₃₁ and LP₁₂ modes. Therefore, such modes are treated as one propagation mode such as LP₂₁+LP₀₂ and LP₃₁+LP₁₂ in evaluation of the optical characteristics such as a loss of filter and a gain of optical amplifier.

In the mode equalization filter of the present embodiment, the transmission loss of the signal light to the partial ND filter 3 in each propagation mode depends on a radius of the small dot 4 provided on the partial ND filter 3 and having the small transmittance, the transmittance with respect to the small dot 4 having the small transmittance, and the shift amount of the small dot 4 having the small transmittance from the optical axis 101.

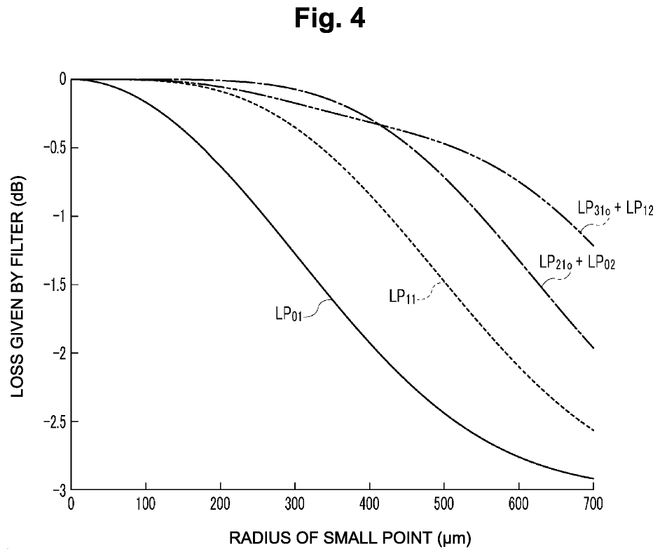

FIGS. 4 to 6 show a transmission loss undergone when light having a wavelength of 1550 nm is used as signal light.

FIG. 4 is a graph showing dependency of a transmission loss given by the partial ND filter 3 on the radius of the small dot 4 having the small transmittance. At this time, the transmittance and the shift amount of the small dot 4 having the small transmittance are 0.5 and 0 μm with respect to the signal light, respectively. A horizontal axis represents the radius of the small dot 4 having the small transmittance, and a vertical axis represents the transmission loss of the signal light to the radius.

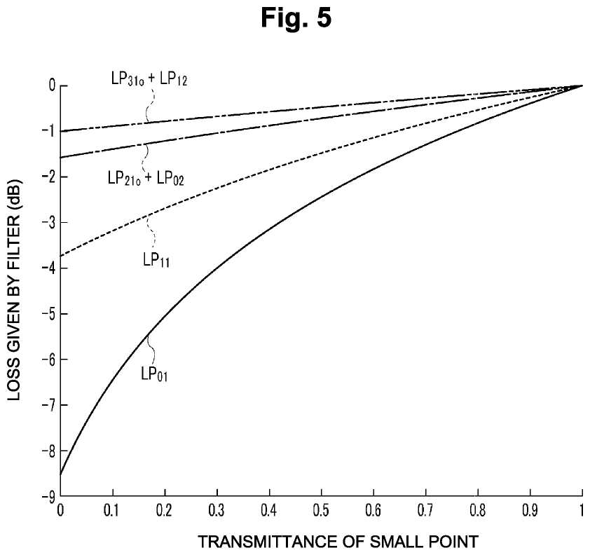

FIG. 5 is a graph showing dependency of a transmission loss given by the partial ND filter 3 on the transmittance of the small dot 4 having the small transmittance. At this time, the radius and the shift amount of the small dot are 500 μm and 0 μm, respectively. A horizontal axis represents the transmittance of the small dot 4 having the small transmittance, and a vertical axis represents the transmission loss of the signal light to the transmittance.

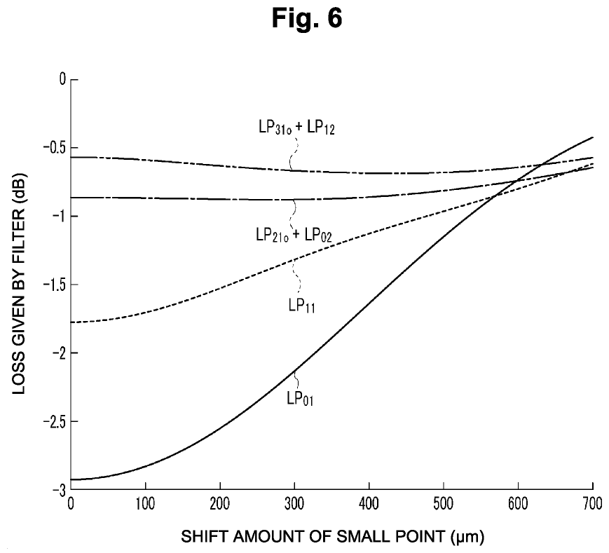

FIG. 6 is a graph showing dependency of a transmission loss given by the partial ND filter 3 on the shift amount of the small dot 4 having the small transmittance from the optical axis 101. At this time, the radius of the small dot 4 having the small transmittance is 500 μm, and the transmittance of the small dot 4 having the small transmittance is 0.5. A horizontal axis represents the shift amount of the small dot 4 having the small transmittance from the optical axis 101, and a vertical axis represents the transmission loss of the signal light to the shift amount. Here, the shift amount of the small dot 4 having the small transmittance from the optical axis 101 indicates a moving distance of the partial ND filter 3 when the partial ND filter 3 moves along the axis 102 perpendicular to the optical axis from a reference position at which the partial ND filter 3 is arranged such that optical axis passes through the center of the small dot provided on the partial ND filter 3 and having the small transmittance.

As can be seen from FIGS. 4 to 6, the transmission loss given by the partial ND filter 3 depends on the following three factors: firstly, the radius of the small dot 4 having the small transmittance; secondly, the transmittance of the signal light with respect to the small dot 4 having the small transmittance; and thirdly, the shift amount of the small dot 4 having the small transmittance from the optical axis 101. Further, the degree of the dependency of the transmission loss on the partial ND filter 3 differs depending on each of the propagation modes. Therefore, an operator can give a predetermined transmission loss of the signal light for each propagation mode by setting the radius of the small dot 4 having the small transmittance, the transmittance of the signal light with respect to the small dot 4 having the small transmittance, and the shift amount of the small dot 4 having the small transmittance from the optical axis 101 to predetermined values, respectively.

In other words, it is possible to obtain the effect in which the transmission loss of the signal light is reduced to be different for each propagation mode by a predetermined setting of such factors.

A more specific example according to the present embodiment will be described. In the mode equalization filter of the present embodiment, the radius of the small dot 4 having the small transmittance is set to 650 μm, the transmittance of the signal light with respect to the small dot 4 having the small transmittance is set to 0.11, and the shift amount of the small dot 4 having the small transmittance from the optical axis 101 is set to 300 μm, so that the transmission loss of each propagation mode can be set to 7.0 dB in the mode LP₀₁, 4.6 in the mode LP₁₁, 3.1 dB in the mode LP₂₁+LP₀₂, and 2.3 dB in the mode LP₃₁+LP₁₂.

According to a configuration of an optical amplifier using a conventional FMF, a gain difference in the optical signal between the propagation modes is 2.6 dB between the modes LP₀₁ and LP₁₁, 4.1 dB between the modes LP₀₁ and LP₂₁+LP₀₂, 5.1 dB between the modes LP₀₁ and LP₃₁+LP₁₂, 1.5 dB between the modes LP₁₁ and LP₂₁+LP₀₂, 2.5 dB between the modes LP₁₁ and LP₃₁+LP₁₂, and 1.0 dB between the modes LP₂₁+LP₀₂ and LP₃₁+LP₁₂. The gain difference in the optical signal between the propagation modes mainly occurs due to the difference in the transmission loss of the optical signal that differs depending on each propagation mode. Therefore, when the mode equalization filter according to the present embodiment is applied to the configuration of the optical amplifier using the FMF, the gain differences in the optical signal between the propagation modes are reduced to 0.2 dB, 0.2 dB, 0.4 dB, 0.0 dB, 0.2 dB, and 0.2 dB, respectively.

In other words, the mode equalization filter of the present embodiment can also be used to reduce the gain differences in the optical signal between the propagation modes when being applied to the configuration of the optical amplifier using the FMF.

Furthermore, the mode equalization filter of the present embodiment can be configured in which a sliding mechanism 5 (not shown) is connected to the partial ND filter 3 to displace the partial ND filter 3 in the direction of the axis 102 perpendicular to the optical axis. The sliding mechanism 5 can be configured by, for example, a guide member parallel to the axis 102 perpendicular to the optical axis. For example, the mechanism is preferably configured such that the partial ND filter 3 is fixed to a locking member that is slidably fitted to the guide member, one side of partial ND filter 3 is elastically mounted by an elastic member such as a spring, and the other side of the partial ND filter 3 is provided and pressed on and against a micrometer head, thereby displacing the micrometer head to displace the position of the partial ND filter. Further, the configuration and the mechanism of the sliding mechanism 5 can allow the light collimated by the collimator lens 2a to reach the partial ND filter 3 without blocking the light, and is not particularly limited as long as the configuration and the mechanism are those in which the displacement of the partial ND filter 3 causes the change of the position at which a part of the cross section of the collimated light parallel to the plane overlaps with a part of the small dot 4 provided on the partial ND filter 3 and having the small transmittance.

For example, in the mode equalization filter of the present embodiment, when the sliding mechanism 5 is further provided to displace the partial ND filter 3 and the shift amount of the small dot 4 having the small transmittance from the optical axis 101 is set to 0 μm, the transmission loss of each propagation mode is 8.9 dB in the mode LP₀₁, 6.8 dB in the mode LP₁₁, 4.4 dB in the mode LP₂₁+LP₀₂, and 2.4 dB in the mode LP₃₁+LP₁₂. In other words, as compared with the case where the shift amount of the small dot 4 having the small transmittance from the optical axis 101 is 300 μm, it is possible to obtain the transmission loss different in each propagation mode.

### Second Embodiment

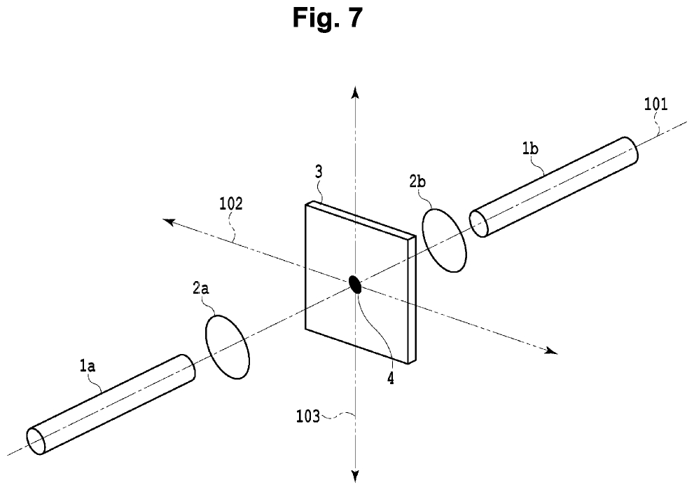

FIG. 7 is a perspective view schematically showing a configuration of a mode equalization filter according to a second embodiment of the present invention. The mode equalization filter of the present embodiment has the same configuration and arrangement of respective components as those of the mode equalization filter of the first embodiment. A difference is in that a triaxial sliding mechanism 6 (not shown) is connected to the partial ND filter 3 and is installed such that the partial ND filter 3 is movable in three directions in which the axis 102 perpendicular to the optical axis, an axis 103 perpendicular to the optical axis and orthogonal to the axis 102, and the optical axis 101 are orthogonal to each other.

Since the triaxial sliding mechanism 5 is further provided, it is possible to secure a margin in the arrangement of the FMFs 1a and 1b, the collimator lens 2a, the condensing lens 2b, the partial ND filter 3, and the small dot 4 having the small transmittance are formed in the optical axis direction and in a plane perpendicular to the optical axis. According to the mode equalization filter of the present embodiment, even when relative positions of these components change during the operation of the mode equalization filter, the position of the partial ND filter 3 is appropriately displaced using the triaxial sliding mechanism 6, and thus desired loss characteristics are obtained.

For example, when the installation position of the collimator lens 2a is changed by 1.5 μm in the direction of the FMF 1a along optical axis 101 compared with the arrangement of the mode equalization filter of the first embodiment, the position of the partial ND filter 3 is displaced by about 1 μm in the direction of FMF 1a along the optical axis 101 using the triaxial sliding mechanism 6, and thus the value of the transmission loss of the signal light between respective propagation modes can be obtained as in the first embodiment. Further, the effect (mode equalization characteristic) of reducing the transmission loss of the signal light by different amounts for each propagation mode is obtained by setting the radius of the small dot 4 having the small transmittance, the transmittance of the signal light with respect to the small dot 4 having the small transmittance, and the shift amount of the small dot 4 having the small transmittance from the optical axis 101 to predetermined values, respectively.

### REFERENCE SIGNS LIST

1a, 1b FMF

2a Collimator lens

2b Condensing lens

3 Half ND filter

4 Small dot having small transmittance

5 Sliding mechanism

6 Triaxial sliding mechanism

1. A mode equalization filter that reduces a difference in light intensity between multiple modes of signal light propagating in a core of a few-mode fiber, comprising:
a collimator lens that collimates the signal light emitted from the few-mode fiber;
a partial ND filter including a small dot having small transmittance with respect to the collimated signal light; and
condensing lenses that condense the signal light transmitted through the partial ND filter on the few-mode fiber, wherein
the small dot having the small transmittance is arranged in a part of the partial ND filter, and
the partial ND filter is arranged such that, when the collimated signal light is transmitted, a part of the collimated signal light overlaps with the small dot having the small transmittance.

2. The mode equalization filter according to claim 1, wherein an intensity of signal light passing through the small dot having the small transmittance and transmitted through the partial ND filter is smaller than an intensity of signal light passing through the partial ND filter and transmitted through the partial ND filter.

3. The mode equalization filter according to claim 2, further comprising:
a sliding mechanism that displaces the partial ND filter in at least one of a first direction parallel to an optical axis in which the collimated signal light advances, a second direction perpendicular to the optical axis, and a third direction orthogonal to the first direction and the second direction, wherein
due to the displacement, a position where a part of a cross section of the collimated signal light parallel to a plane of the partial ND filter overlaps with a part of the small dot having the small transmittance is displaced.
